(19) United States
(12) Patent Application Publication
(10) Pub. No.: US 2008/0156215 A1
(43) Pub. Date: Jul. 3, 2008

(54) PRINTING PROCESS FOR PLUSH FABRIC

(76) Inventor: Daniel Dean Atkins, Folsom, CA (US)

Correspondence Address: BANNER & WITCOFF, LTD., 1100 13th STREET, N.W., SUITE 1200, WASHINGTON, DC, 20005-4051, US

(21) Appl. No.: 12/048,712

(22) Filed: Mar. 14, 2008

Related U.S. Application Data
(62) Division of application No. 10/226,275, filed on Aug. 23, 2002.

(51) Int. Cl. B41D 7/04; A63H 3/02

(52) U.S. Cl. 101/493; 446/369

(57) ABSTRACT

Images printed and transferred to plush fabric and a method for printing and transferring images to plush fabric are described. Through a dye-sublimation process, dye sublimation agents can be permanently embedded into the fibers of plush fabric. The dye-sublimation process allows for precise images, including images of photo quality or near-photo quality, to be transferred to the plush fabric. Pieces of the plush fabric can be combined and arranged to create, for example, a stuffed animal with an image that extends across the body and appendages of the animal.

### CROSS REFERENCE TO RELATED APPLICATIONS

This application is a divisional of co-pending U.S. patent application Ser. No. 10/226,275, filed Aug. 23, 2002 in the name of Daniel Dean Atkins, entitled “Printing Process for Plush Fabric.” This earlier priority application is entirely incorporated herein by reference.

### FIELD OF THE INVENTION

The invention relates to toys and collectibles. More specifically, the invention relates to a process for printing and transferring images to plush fabric and to manufacturing plush toys with images printed on their fabric.

### BACKGROUND OF THE INVENTION

Toys and collectibles such as stuffed animals covered with plush fabric are well known. Such toys and collectibles can be made of soft fabric resembling animal fur. These toys and collectibles are referred to as plush toys. Plush fabric can be colored, but the individual fabric components that form parts of plush toys, such as an arm or a leg of a stuffed animal, often cannot include more than one color because each piece of fabric used to make the plush toy (based on a preset sewing pattern) can only be a single color. For example, a stuffed animal made with plush fabric may have a white body and blue arms and legs, which are formed separately from the body of the stuffed animal. The separately colored appendages must be attached, such as by sewing, to the body.

Plush toys can also be colored with several different colors, such as through a process of hand dying or painting. Such techniques are limited, though, and provide only limited amounts of detail in the resulting color variation. For example, dyes, paints, and other forms of coloring the fabric might not penetrate the fibers of the fabric. Such paints and dyes that do not penetrate the fibers often rub off, or “bleed,” if the fabric is handled. The paints and dyes often also appear faded or washed out. In addition, the dye or coloring may affect the suppleness and drape of the plush fabric, hindering the aesthetic appearance or feel of the fabric.

The use of dyes or paints to color plush fabrics with multiple colors also might not achieve a sharp contrast between adjacent colors, limiting the detail level of images that can be displayed on the fabric, if at all. For example, a stuffed animal may be colored with rainbow colors, where no specific transition between colors is necessary. When the dye bleeds into the next color, the visual effect is not diminished. However, any bleeding of a black color into a white area would produce an unsightly gray transition, which would affect the aesthetic appearance of the plush toy. Similarly, such techniques cannot be used to color plush fabric with detailed images containing small features. Any bleeding of one color into the next may distort or destroy such an image, hindering the aesthetic appearance of the toy or collectible.

### BRIEF SUMMARY OF THE INVENTION

Many of the aforementioned problems are solved by providing a process for printing and transferring images to plush fabric, embedding a detailed image in the plush fabric. For example, an image is transferred to a piece of plush fabric through a dye sublimation process. After rendering onto a transfer sheet a mirror image of the desired image to be transferred to the plush fabric, the sheet can be placed atop the plush fabric for transferring of the dye sublimation agent (e.g., dye or toner). The agent can be heated to transfer the image to the plush fabric. For example, the dye sublimation agent vaporizes when it is heated to a temperature above its sublimation temperature. The vapor penetrates the fibers of the plush fabric, embedding the agent in the fabric and rendering a permanent or long-lasting color change. Images on plush fabric produced by such a process retain the details included in the rendering of the mirror image on the transfer sheet, and are detailed enough such that discernible images are visible on the resulting plush toy.

Various objects can be made from plush fabric, such as stuffed animals, soft toys for children or pets, clothing, plush collectibles, etc. Such objects can include several pieces of plush fabric attached together, e.g., by sewing. The images printed on the plush fabric can be altered or arranged in any combination to improve the overall appearance of the assembled object. For example, the images on the several pieces of plush fabric can be printed such that, when they are assembled together into an object, a single image appears to extend across the entire object, across any appendages. Alternatively, identical or similar images can be printed on each piece of plush fabric. Similarly, some pieces of plush fabric can have a mirror image of an image printed on other pieces of plush fabric used to form the object.

These as well as other advantages and aspects of the invention are apparent and understood from the following detailed description of the invention, the attached claims, and the accompanying drawings.

### BRIEF DESCRIPTION OF THE DRAWINGS

The patent or application file contains at least one drawing executed in color. Copies of this patent or patent application with color drawing(s) will be provided by the Office upon request and payment of the necessary fee.

A more complete understanding of the present invention and the advantages thereof may be acquired by referring to the following description in consideration of the accompanying drawings, in which like reference numbers indicate like features, and wherein:

FIG. 1 illustrates a plush toy bearing an image embedded in its plush fabric, wherein several of the pieces that make up the plush toy bear the same image.

FIG. 2 illustrates a plush toy bearing an image embedded in its plush fabric, wherein a single image extends across the entire plush toy.

FIG. 3 illustrates a plush toy bearing an image embedded in its plush fabric, wherein pieces that make up the plush toy bear a mirror image of the image on other pieces that make up the plush toy.

FIG. 4 illustrates a method for creating a plush toy, such as those depicted in FIGS. 1, 2, and 3, including an image or images embedded in the plush fabric of the plush toy.

FIG. 5 illustrates a portion of a pattern template that can be used to manufacture a plush toy.

FIG. 6 illustrates a portion of an image-filled pattern.

FIG. 7 illustrates a product produced using an illustrative embodiment of the inventive process.

### DETAILED DESCRIPTION OF THE INVENTION

The invention described herein may be used to create plush toys with detailed images, such as representations of photographs, artwork, multicolored drawings, and the like, printed thereon. The invention is described using as an illustration a plush toy, such as a stuffed animal. However, the invention can be embodied in various forms, and it can be implemented in various ways to make other objects formed from plush fabric, such as toys, clothing, collectibles, etc. The invention, therefore, is not limited to the general context of toy figures, such as bears, made of plush fabric.

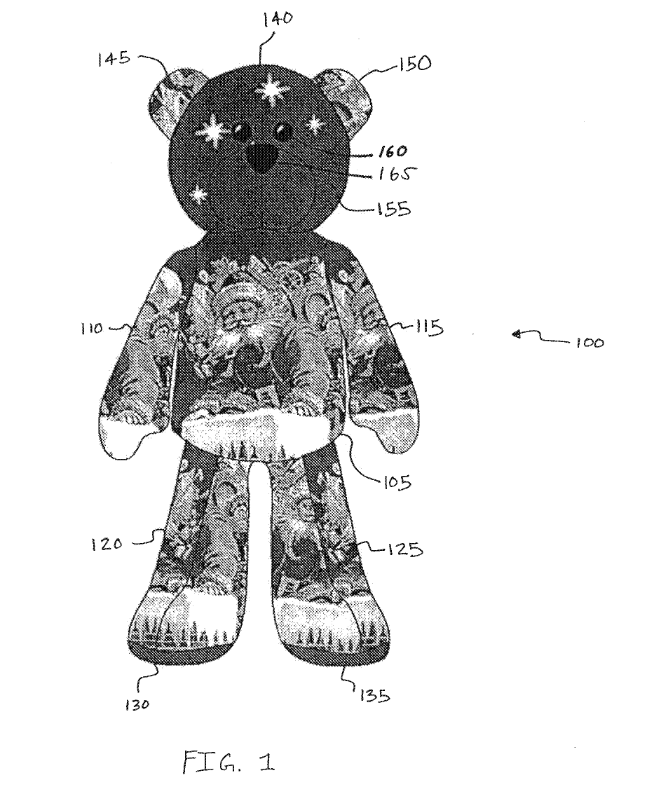

FIG. 1 illustrates a first embodiment of a plush toy 100. The plush toy 100 is formed from several different components made of plush fabric. For example, the plush toy 100 can include one or more of the following components: a body 105, a right arm 110, a left arm 115, a right leg 120, a left leg 125, a right foot 130, a left foot 135, a head 140, a right ear 145, a left ear 150, and a snout 155. Each of these components can be joined together, such as by sewing, and stuffed to form a single toy 100. The plush toy may also include non-plush features such as eyes 160 and nose 165

The plush toy 100 can include printed images transferred onto the surface of its plush fabric. In this first embodiment, many of the components may have the same image printed on them, creating a unique aesthetic appearance. For example, the body 105, the arms 110 and 115, the legs 120 and 125, and the ears 145 and 150 may have an image of Santa Claus printed on them. The plush toy 100 may also have a back portion (not shown) or other components (not shown), which can include the same or a different image as the body 105 or other components of the plush toy 100.

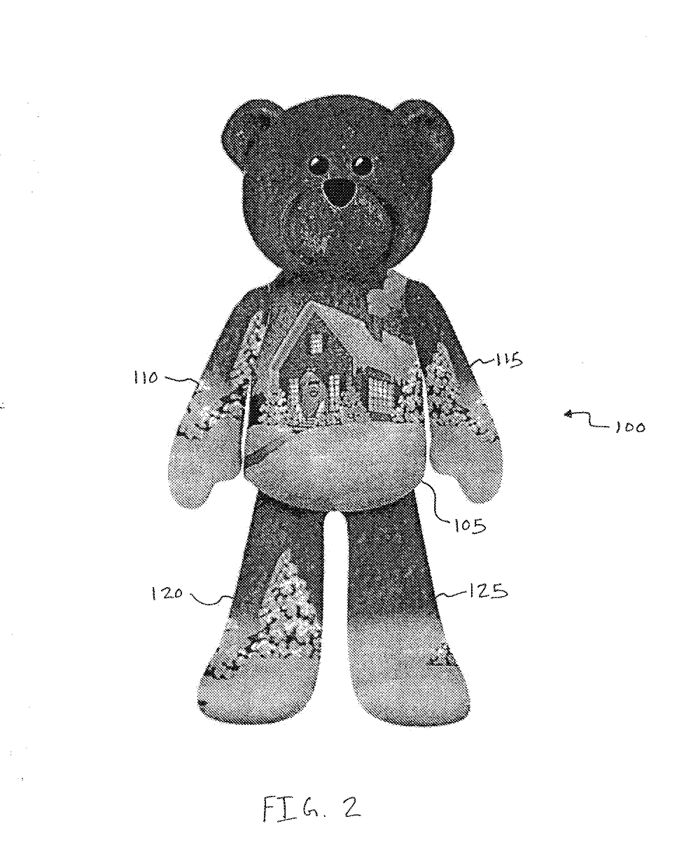

FIG. 2 illustrates a second embodiment of plush toy 100. In this embodiment, the plush toy 100 contains a single image, extending across the plush toy 100. For example, the image imprinted on the right arm 110 is different than the images imprinted on the body 105 and the left arm 115 of the plush toy 100. Similarly, the images imprinted on the legs 120 and 125 are different than the images imprinted on the body 105 and the right and left arms 110 and 115. When the components are combined to form the plush toy 100, the separate images come together to create the visual impression of a single, uniform image extending across the entire body of the plush toy 100, creating a unique aesthetic appearance.

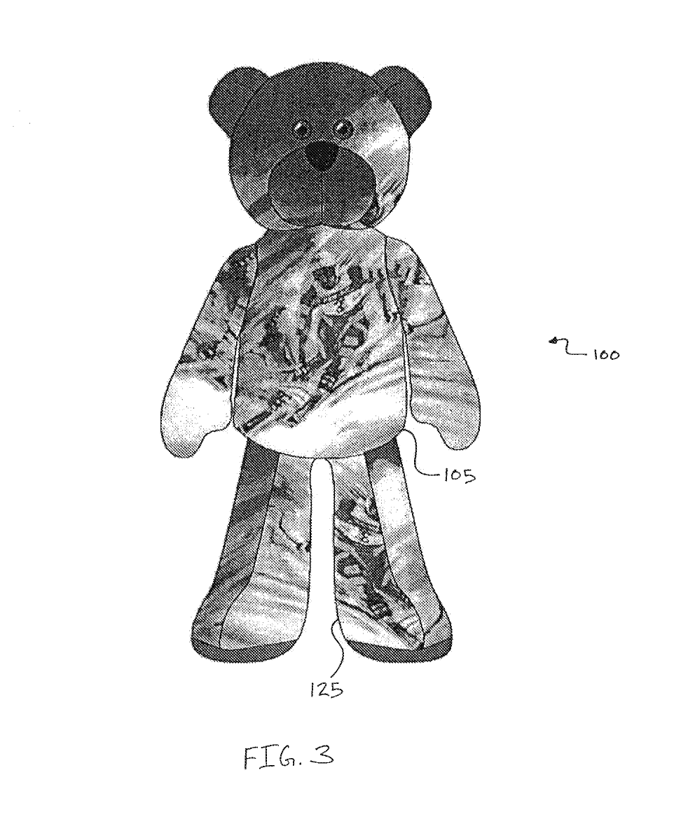

FIG. 3 illustrates a third embodiment of plush toy 100 with an image embedded in its plush fabric. In this embodiment, like in the first embodiment shown in FIG. 1, many of the components are imprinted with the same image. However, unlike the first embodiment shown in FIG. 1, some of the components have mirror images of the images imprinted on other components. For example, a mirror image of the image imprinted on the body 105 is imprinted on the left leg 125, creating a unique aesthetic appearance.

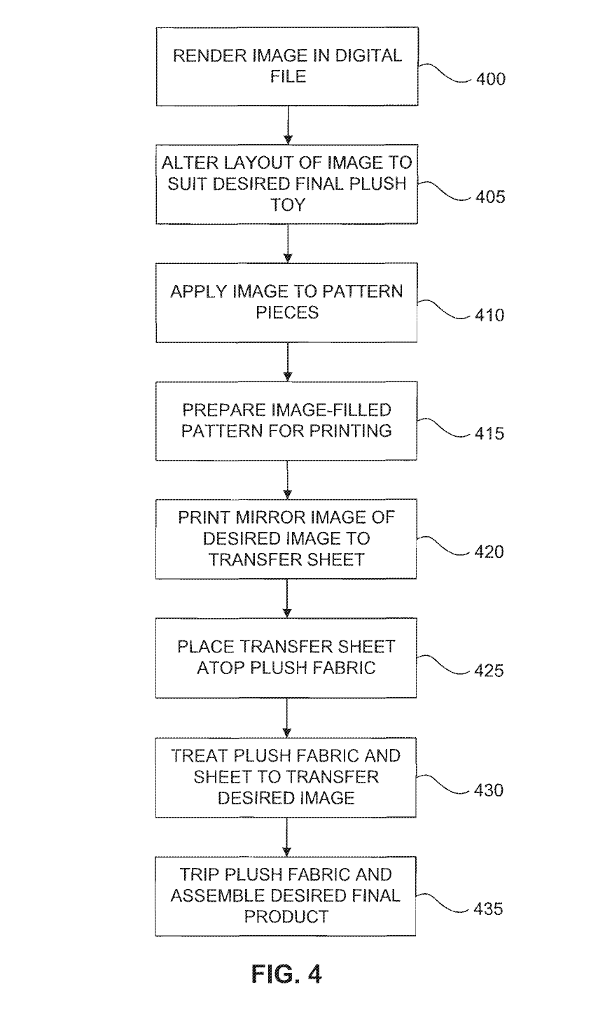

FIG. 4 illustrates a method according to an illustrative embodiment of the invention for making a plush toy with an image embedded into its plush fabric, for example, plush toy 100 as illustrated in any of FIGS. 1-3. The desired image is first rendered in a digital file (step 400), referred to as a digital image. The digital image can be captured using a digital camera, drawn or manipulated with computerized image or drawing software (e.g., ADOBE® PHOTOSHOP®, CORELDRAW®, MICROSOFT® PICTURE IT!®, or obtained from some other source. The digital image may be stored in a file of type JPEG, TIFF, bitmap, or the like. Hi-resolution files are preferably used, however, lower-resolution files (e.g., GIF) may alternatively be used. Similarly, the digital image can be obtained from a photograph, a drawing, a painting, or other image by scanning it into a computer as a digital image file using an image scanner. Image scanners are well known in the art.

In step 405 the desired image can be altered to suit the particular plush toy 100 on which it is to be printed. For example, using the image editing software on a computer, the image can be cropped or sized to fit the particular plush toy 100, or its shape can be adjusted (e.g., stretched, skewed, etc.) to fit the contours of the plush toy 100 or component pieces of the plush toy 100, such that the image looks unskewed and/or unstretched when applied to the contours of the plush toy and viewed from a predetermined viewpoint, e.g., straight on from the front.

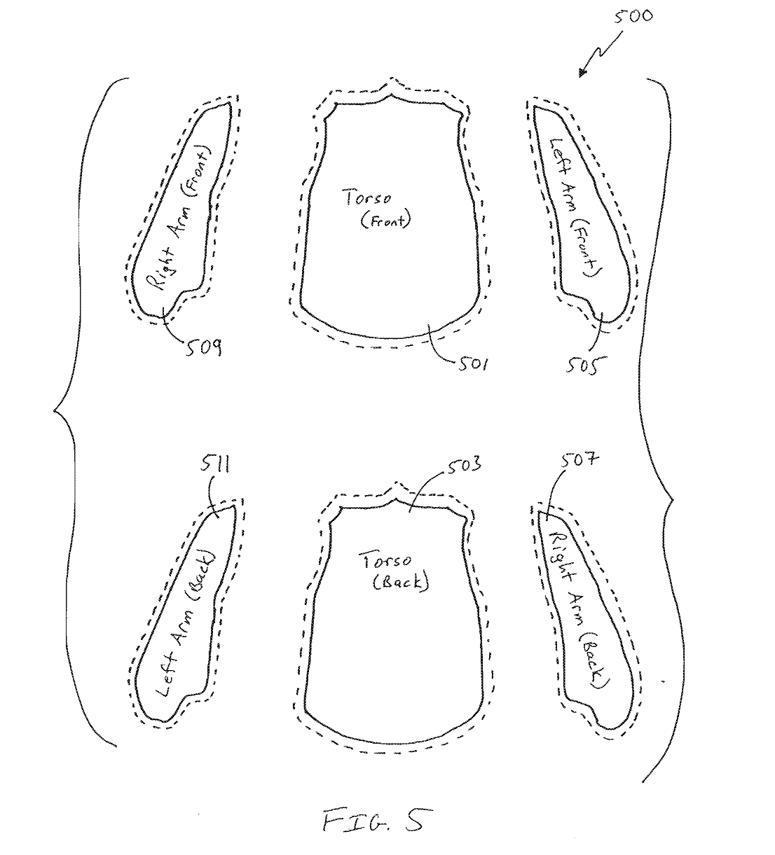

Once the image is prepared for the plush toy 100, in step 410 the image is applied to pieces of a pattern template 500 (FIG. 5) that is used to manufacture the plush toy in a desired shape (e.g., a bear). That is, the image can be divided and/or duplicated into one or more portions corresponding to each piece of the pattern. In one illustrative example, the plush toy 100 shown in FIG. 1 includes several components: a body 105 (which may be made from separate front and back portions), arms 110 and 115, legs 120 and 125, feet 130 and 135, a head 140, ears 145 and 150, and a snout 155. In such a plush toy 100, each component may be a separate piece, or pieces, of the pattern template, and each component may have a different image or portion of the overall image to be printed on the plush toy 100. FIG. 5 illustrates a portion of a pattern template 500 that may be used to manufacture a plush toy as illustrated in FIGS. 1-3. The portion of the pattern template 500 includes a front torso piece 501, a back torso piece 503, a front left arm piece 505, a back left arm piece 507, a front right arm piece 509, and a back right arm piece 511. Other pieces for the head, ears, legs, and feet (not shown) may also be used.

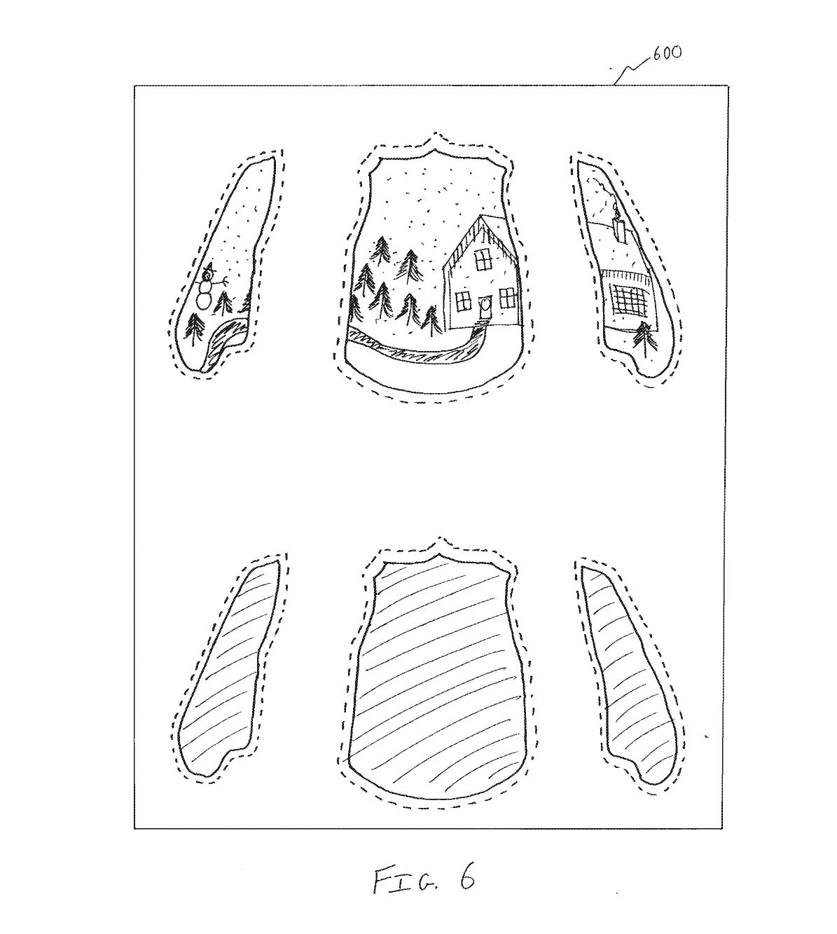

FIG. 6 illustrates a page 600 of the pattern template with portions of an image selected for each piece of the pattern shown. As illustrated in FIG. 6, the back pieces may be solid colors. However, the same or a different image may alternatively be placed on the back of the plush toy. The page 600 may be a piece of special paper (described below) used to print dye-sublimation agents, or may alternatively be some other material, such as canvas or other film as applicable. The pattern pieces with corresponding images is referred to as an image-filled pattern.

After determining which portion of the image is to be applied to each piece in the pattern, the pattern pieces can be prepared for printing (step 415). The image-filled pattern may be grouped together to minimize printing resources. That is, the pieces of the image-filled pattern can be moved close together without overlapping to minimize paper and agent (e.g., dye or toner) resources. Once the pieces are grouped onto pages as desired, each page is reversed to produce a mirror image of the original page (each image is again reversed to produce the intended final image when each image is transferred from the printed sheets to the plush fabric).

After the image has been prepared for printing, the mirror image(s) are printed onto dye sublimation transfer paper (step 420), also referred to as donor paper, such as Jetcol HTR 4000 paper (manufactured by Coldenhove Papier of Eerbeek, Holland, and commercially available at least from FotoWear, Inc. of Carpentersville, Ill.). Any dye-sublimation agent, such as dye sublimation ink or toner, may be used to print on the transfer paper. Similarly, various printers can be used, depending upon the image quality sought or the agent used. For example, an electrostatic dye-sublimation printer, such as the 3M Scotchprint 2000 electrostatic printer (manufactured by 3M of St. Paul, Minn.) or a kV Color system (available from Specialty Toner Corporation of Fairfield, N.J.), is used to print with dye sublimation toners onto the transfer paper. Similarly, specially adapted inkjet printers, such as the NUR FabriGraph (manufactured by NUR Macroprinters Ltd. of Lod, Israel and commercially available at least from NUR America, Inc. of San Antonio, Tex.) or the Mimaki JV4 inkjet printer (available from by Mimaki USA, Inc. of Duluth, Ga.), can be used to print with dye sublimation inks.

The printed transfer paper may be placed adjacent to the plush fabric onto which the image is to be transferred (step 425). The side of the transfer paper onto which the image has been printed should be placed adjacent to the nap side of the plush fabric. For example, the transfer paper may be placed image down atop nap-side-up plush fabric, such that the agent can transfer to the plush fabric when treated. The paper and plush fabric are then treated, e.g., by heating, to transfer the agent from the transfer paper to the plush fabric (step 430). The transfer paper and plush fabric are heated to the sublimation point of the agent, causing the agent to vaporize and penetrate the fibers of the plush fabric. In one embodiment, the transfer paper and plush fabric are heated using a rotary heat transfer printer, or heat press, such as an Astex 7500 printer (commercially available from Astechnologies, Inc. of Roswell, Ga.). Other treatments, e.g., pressure, application of a chemical, etc., may alternatively be used or in combination with heat to provide various effects on the resulting image. Preferred embodiments of the invention use dye sublimation agents that permanently change the color of the fibers in the plush fabric, while not affecting the natural drape and feel of the fibers. Dye sublimation agents are commonly available from the providers of dye sublimation printers, listed above.

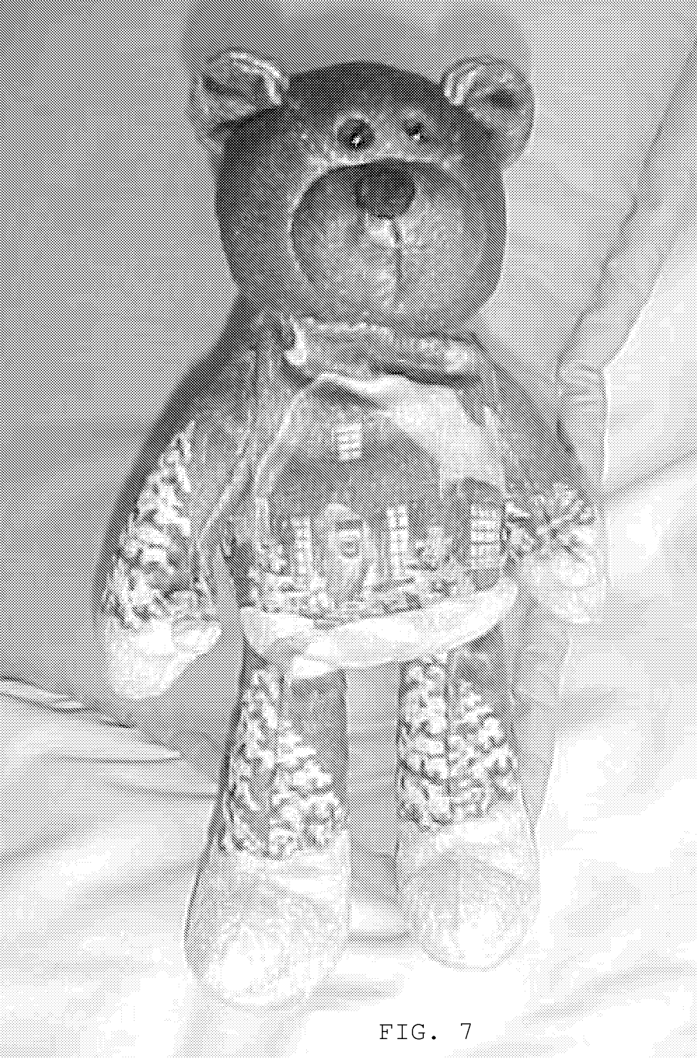

After the image has been transferred to the plush fabric, the plush fabric can be formed into the final product, such as a plush FIG. 100 (step 435). The plush fabric can be trimmed to the shapes required for each of the components as indicated by the pattern pieces printed on the plush fabric. The components are attached together, such as by sewing them together, as is known in the art. Stuffing can be added to fill vacant cavities in the plush fabric once the components are attached together, and the various components can be assembled into the final product. FIG. 7 illustrates a plush toy manufactured using the process illustrated in FIG. 4.

Because colors may be altered during the manufacturing process, raster image processor software can be used to ensure that the colors on the final product plush toy 100 match those of the desired image. For example, the colors of certain dye sublimation agents can change when the agents are heated during dye sublimation. The raster image processor software can determine which color should be printed on the transfer paper in order to obtain the desired color after the agent is treated.

Alternately, the printing process can be tested and the colors in the image can be altered based on the results of the tests. For example, if the process produces a blue color on the plush fabric that appears too dark, the color in the image can be lightened. This process can be repeated until the printing process produces the desired color on the plush fabric.

While the invention has been described with respect to specific examples including presently preferred modes of carrying out the invention, those skilled in the art can appreciate that there are numerous variations and permutations of the above described systems and techniques that fall within the spirit and scope of the invention as set forth in the appended claims.

I claim:

1. A method of printing an image on a piece of plush fabric, comprising the steps of:
rendering a mirror image of a desired image on a transfer sheet using a dye-sublimation agent;
placing plush fabric adjacent to the transfer sheet; and
treating the dye-sublimation agent to transfer the desired image to the plush fabric.

2. The method of claim 1, wherein the dye sublimation agent comprises dye sublimation toner and wherein rendering a mirror image of the desired image on a transfer sheet comprises printing the mirror image onto the transfer sheet with an electrostatic printer.

3. The method of claim 1, wherein the dye sublimation agent comprises dye sublimation ink and wherein rendering a mirror image of the desired image on a transfer sheet comprises printing the mirror image onto the transfer sheet with an inkjet printer.

4. The method of claim 1, wherein the desired image comprises a plurality of pieces of a pattern corresponding to a plush toy when assembled.

5. The method of claim 4, wherein the process further comprises cutting the plurality of pieces from the plush fabric and assembling the plurality of pieces to form the plush toy.

6. The method of claim 1, wherein a plurality of desired images are provided on a plurality of pieces of plush fabric, the plurality of pieces forming a pattern corresponding to a plush toy when assembled.

7. The method of claim 6, wherein the plush toy comprises a bear.

8. The method of claim 1, wherein the process further comprises:
receiving a digital image in a computer;
creating an image-filled pattern by matching a portion of the digital image to each of a plurality of pieces of a pattern corresponding to a plush toy; and
generating the desired image based on the image-filled pattern.

9. The method of claim 8, wherein the portion of the digital image matched to each of the plurality of pieces is non-repeating.

10. The method of claim 8, wherein the portion of the digital image matched to each of the plurality of pieces comprises repeating portions.
